(19) United States
(12) Patent Application Publication
(10) Pub. No.: US 2008/0066372 A1
(43) Pub. Date: Mar. 20, 2008

(54) Organic insect extermination lamp

(76) Inventor: Tom Fleming, San Diego, CA (US)

Correspondence Address: Maryanne DeAngelo, 1213 Avocet Court, Cardiff by the Sea, CA, 92007, US

(21) Appl. No.: 11/522,822

(22) Filed: Sep. 18, 2006

(51) Int. Cl. A01M 1/04; A01M 13/00; A01M 1/20

(52) U.S. Cl. 43/113; 43/129

(57) ABSTRACT

Disclosed embodiments provide a method and apparatus for an organic insect extermination lamp, which continuously kills mosquitoes and other biting insects without the use of chemicals, pesticides or electrocution. The present organic insect extermination lamp has no detrimental effects on human health or the environment. The organic insect extermination lamp comprises a fixture having a power supply and a light source for attracting mosquitoes and other biting insects and at least one container for holding a natural exterminating substance, wherein the natural exterminating substance evaporates natural exterminating vapors for killing the mosquitoes and other biting insects. The natural exterminating substance may comprise any Allyl Sulfide emulsion or any other organic compound. An Allyl Sulfide emulsion may contain garlic oil, garlic paste, garlic emulsion, crushed fresh garlic, or other forms of natural killing compounds.

### BACKGROUND

1. Field

The presently disclosed embodiments relate generally to insect extermination devices, and more specifically to a lamp for exterminating mosquitoes and other biting insects by evaporation of a wholly organic compound.

2. Background

Every year over a million people worldwide die from mosquito-born diseases such as Malaria, Dengue, Encephalitis, and West Nile Virus. Artificial light sources exacerbate the spread of disease by attracting mosquitoes to areas of human activity. Chemical insecticides used in these areas have further cumulative detrimental health effects and damaging environmental repercussions. Merely repelling, rather than exterminating mosquitoes and other infectious biting insects, does not prevent local migration to adjacent areas.

Known methods for repelling or destroying mosquitoes and other biting insects are unreliable and produce unpleasant effects. Netting and screens inhibit ventilation and concentrate insects near light sources. Ultraviolet electrocution devices produce disturbing sounds and smells while upsetting the eco-system by killing more beneficial insects than mosquitoes. Traps are largely ineffective because only a small percentage of biting insects are successfully maneuvered into such devices. Chemical insecticides are marginally effective, poison the environment and result in progressively worsening human health.

Traps and ultraviolet zappers are not only ineffective but often do more harm than good because they attract mosquitoes without killing them. Ultraviolet light aids mosquitoes in finding water to lay their eggs by polarizing light reflected off the surface of water. Each night, a typical ultra violet zapper kills approximately 3,000 beneficial insects such as moths and butterflies, which pollinate flowers, but only a few mosquitoes. Less than one fourth of one percent of insects killed by traps and zappers have been found to be biting insects. Nearly half have been found to be beneficial non-biting aquatic insects such as caddisflies and midges that feed fish, frogs, birds and bats. Another 14 percent have been found to be insects that actually attack pests including wasps, ground beetles and ladybugs.

Thus, there is a need in the art for a pleasant and effective method of exterminating mosquitoes and other biting insects using only natural organic compounds having no adverse effects on human health or the environment.

### SUMMARY

Embodiments disclosed herein address the above-stated needs by providing an organic insect extermination lamp, which continuously kills mosquitoes and other biting insects without the use of chemicals, pesticides or electrocution. The present organic insect extermination lamp has no detrimental effects on human health or the environment.

Accordingly, in one aspect, an insect extermination lamp comprising a fixture having a power supply and a light source for attracting mosquitoes and other biting insects and at least one container for holding a natural exterminating substance, wherein the natural exterminating substance evaporates natural exterminating vapors for killing the mosquitoes and other biting insects is disclosed.

### BRIEF DESCRIPTION OF THE DRAWINGS

FIG. 1 illustrates an alternating current powered open container organic insect extermination lamp in accordance with one embodiment of the present invention;

FIG. 2 illustrates a solar powered single open container LED lighted organic insect extermination lamp in accordance with one embodiment of the present invention;

FIG. 3 illustrates a perspective view of a single vented container organic insect extermination lamp in accordance with one embodiment of the present invention; and

FIG. 4 illustrates a perspective cutaway view of a solar powered dual vented container organic insect extermination lamp in accordance with one embodiment of the present invention.

### DETAILED DESCRIPTION

The word “organic” is used herein to mean “of, relating to, or derived from living organisms.”

The word “natural” is used herein to mean “as being in accordance with or determined by nature: having or constituting a classification based on features existing in nature.”

The words “natural” and “organic” are used herein to mean having no detrimental effects on human health or the environment in any quantity.

The words “mosquitoes” and “other biting insects” are used herein to mean “mosquitoes, gnats, noseeums and/or any other species of insect pests known to bite mammals for food.”

The word “exemplary” is used exclusively herein to mean “serving as an example, instance, or illustration.” Any embodiment described herein as “exemplary” is not necessarily to be construed as preferred or advantageous over other embodiments.

Mosquitoes and other biting insects have developed a variety of sensors for detecting food through centuries of evolution. Adult biting female mosquitoes have a sophisticated group of three sensors including light, heat, and chemistry. The compound eyes of mosquitoes detect high contrast between light and dark at night. Mosquitoes are attracted to light and heat sources, which can be detected from a distance. A mosquito's chemistry sensors can detect moisture and carbon dioxide expelled in human breath. Mosquitoes are also attracted to a plethora of species specific scents.

The presently disclosed organic insect extermination lamp attracts mosquitoes and other biting insects by natural stimulation of their light, heat and chemical sensors. Only these biting insects are then exterminated with organic compounds evaporated by the presently disclosed lamp. The organic insect extermination lamp is a continuous, all natural, quiet killing system, which contains no pesticides, synthetic chemicals or propane. The disclosed embodiments of organic extermination lamps provide pleasant night time lighting while allowing use of outdoor, decks, patios, porches, backyards and camping areas free from biting insects.

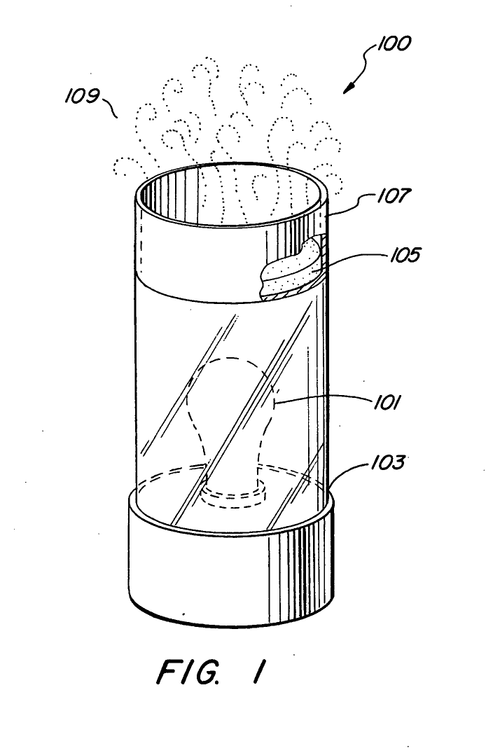

Embodiments of organic extermination lamps described in FIG. 1 through FIG. 4 comprise interchangeable power supply, light, heat, and container means for distributing evaporative organic vapors. Various combinations of components can be used to configure incandescent, florescent, Light Emitting Diode (LED), ultraviolet or open flamed lamps powered by Alternating Current (AC), batteries or solar energy having single or multiple open or vented distribution containers.

FIG. 1 illustrates an exemplary embodiment of an AC powered open container organic insect extermination lamp. Lamp 100 comprises light and heat source 101 housed in fixture 103 for vaporizing natural exterminating substance 105 from container 107. Optionally, a second bottom container (not shown) may also hold additional natural exterminating substance.

Light and heat source 101 may comprise an AC powered incandescent bulb, fluorescent bulb, ultraviolet bulb or LED. Mosquitoes and other biting insects are attracted to light and heat source 101 from substantial distances. In addition to providing pleasant nighttime lighting and attracting mosquitoes, light and heat source 101 heats natural exterminating substance 105 held by container 107 to an optimal evaporative temperature. Light and heat source 101 is selected to generate adequate heat for attracting mosquitoes without over heating natural exterminating substance 105 (i.e. cooking the substance rather than producing a slow evaporation of substance 105 properties lethal to mosquitoes).

In one embodiment, a 25 Watt incandescent globe bulb generates the optimal amount of heat to aid evaporation. During the day, in Spring and Summer, the ambient temperature will provide evaporation. At night, the heat by product of the 25 Watt bulb produces optimal heat to assist evaporation, providing continuous extermination. In another embodiment, an earth friendly 13 Watt Compact-Fluorescent bulb 101 generates enough heat to warm natural exterminating substance 105 using less energy and lasting approximately ten times longer than an incandescent bulb. 13 Watt Compact-Fluorescent bulb 101 safely heats natural exterminating substance 105 to optimal temperatures between 106.6 degrees F. and 109.9 degrees F. while providing the equivalent of 60 Watts of incandescent lighting.

Decomposition of natural plants begins shortly after being picked. During the first stage of natural plant decomposition, vapors are given off. Plants containing natural sulfides produce sulfide vapors. Natural exterminating substance 105 comprises a suspension of organic compound in an evaporable liquid. In one embodiment, natural exterminating substance 105 is a suspension of Allyl Sulfide in oil, which produces natural sulfide vapors 109 when evaporated. Allyl Sulfide is a natural sulfide found in plants such as garlic, onions and Mahogany trees. Allyl Sulfides are unstable natural sulfides, which break down in the heating process to produce evaporative fumes 109 that paralyze the nervous system of mosquitoes, gnats, and other biting insects resulting in death, in quantities as small as a few parts per million. Thus, even a negligible concentration of evaporative Allyl Sulfide vapor 109 kills mosquitoes without harm to human health or the environment.

In an exemplary embodiment, suspension of garlic oil concentrate in cooking oil kills mosquitoes twenty four hours a day for three weeks or more. Cooking oil, such as canola oil, is a high temperature medium, which does not burn off at the low temperatures generated by heat and light source 101. A ratio of one part garlic oil concentrate to ten parts cooking oil instantly kills mosquitoes as they approach the heated lamp.

One skilled in the art would recognize that various embodiments of the present invention can be produced such as a solar powered lamp that charges a battery for nighttime lighting of an LED, incandescent, ultraviolet, or fluorescent bulb. Exterminating ingredients may be garlic oil, garlic paste, garlic emulsion, crushed fresh garlic, or other forms of natural killing compounds. Scent attractant may be added to any Allyl Sulfide emulsion or other natural killing compound.

Various embodiments of the present invention may be produced for outdoor free standing table lighting, stake lighting, post lighting, wall mounted lighting, hanging lighting or decorative lighting. Decorative lighting may comprise organic insect extermination lamp components embedded in a wine glass, marguerita glass, vase, or other tableware or artistic motifs.

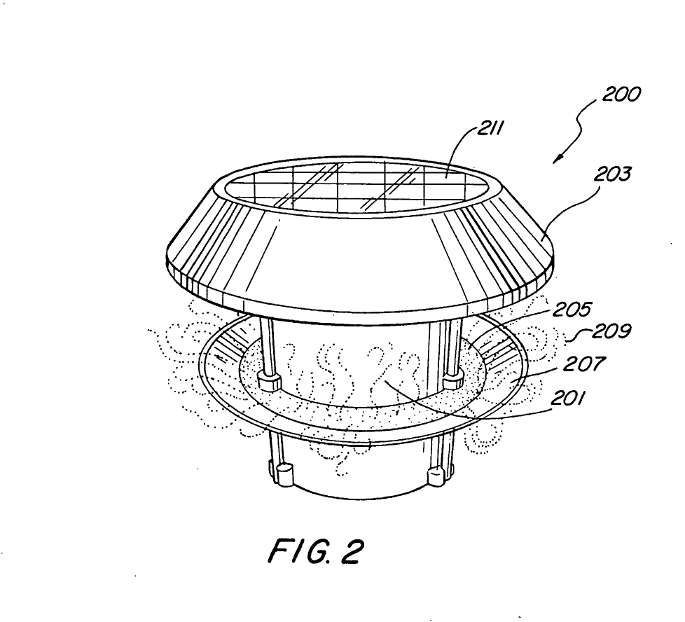

FIG. 2 illustrates an exemplary embodiment of a solar powered single open container LED lighted organic insect extermination lamp. Lamp 200 comprises LED light source 201 housed in fixture 203 for vaporizing natural biting insect exterminating substance 205 from container 207. Alternately, Container 207 may be located at the base of fixture 203. In another embodiment, lamp 200 comprises an additional container (not shown) located at the base of fixture 203. Natural exterminating substance 205 may comprise any Allyl Sulfide emulsion or other natural mosquito killing compound that produces exterminating vapors 209.

Fixture 203 comprises a solar cell 211 for supplying power to LED light source 201. LED light source 201 may be powered by AC or battery in addition to, or instead of, solar energy. In one embodiment, solar cell 211 charges batteries during daylight hours for lamp 200 use at night. In other embodiments, a user may charge rechargeable batteries with an AC source, plug in and operate directly with AC, or insert batteries for an evening of outdoor activity. Bright light from a single LED light source 201 powered by two AA rechargeable batteries provides sufficiently bright light for attracting mosquitoes such that heat as a by product of an incandescent light bulb is not necessary.

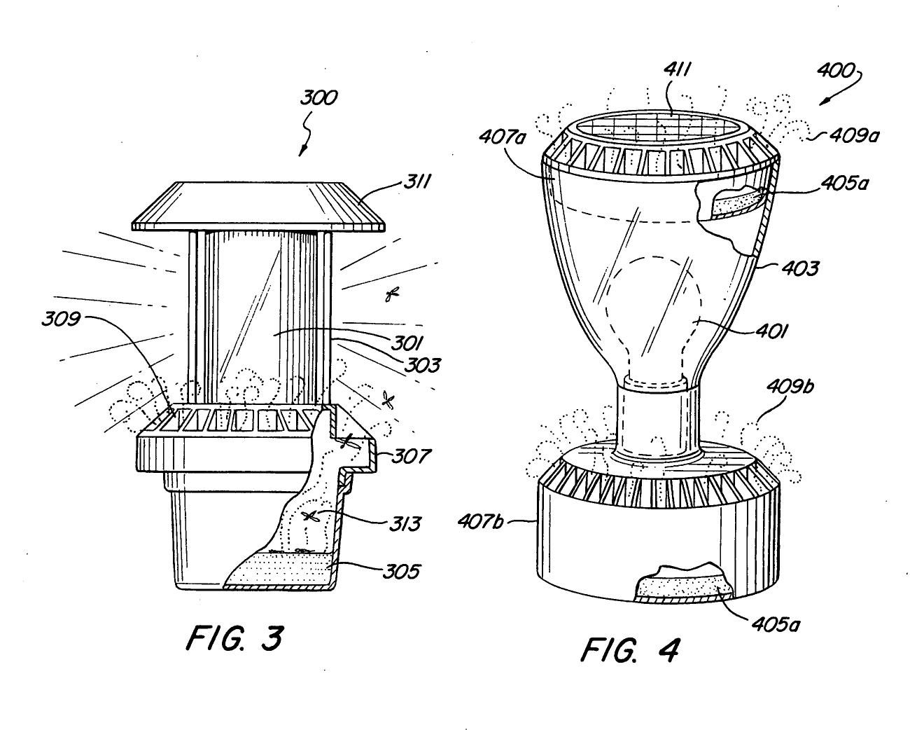

FIG. 3 illustrates a perspective view of an exemplary embodiment of a single vented container organic insect extermination lamp. Lamp 300 comprises light and heat source 301 housed in fixture 303 for vaporizing natural biting insect exterminating substance 305 from vented container 307. Light and heat source 301 may comprise an AC powered incandescent bulb, fluorescent bulb, ultra violet bulb, LED or candle. Light and heat source 301 may be powered by any combination of solar energy, AC or battery. Natural exterminating substance 305 may comprise any Allyl Sulfide emulsion or other natural mosquito killing compound that produces exterminating vapors 309.

Mosquitoes and other biting insects are most active in their search for food during sunset and early evening hours. In one embodiment, where light source 301 is a LED, fixture 303 may comprise an additional heat source as an attractant during sunset and early evening hours. This additional heat source may comprise an unfired black ceramic fixture base that collects heat during the day, and emits its stored heat for approximately an hour as the sun sets. In another embodiment, a small battery operated incandescent bulb provides heat during sunset and early evening hours.

Fixture top 311 may distribute natural evaporative vapors 309 by providing a spinning fan moved by convection heat from light and heat source 301. A fan top embodiment comprises slots or vents at the bottom of fixture 303 to bring in-air, spin the air around the light and heat source 301, an then force the heated air out through the spinning top 311 in order to increase the distribution range of exterminating vapors 309. Alternately, the distribution range of exterminating vapors 309 may be increased by a means for moving air inside the light and heat housing of fixture 303.

Vented base container 307 comprises a slotted, vented, open weave, or perforated cover for facilitating evaporation of exterminating vapors 309 just below the lighted area and hiding any dead mosquitoes 313 that fall into exterminating solution 305 upon expiration. Vented base container 307 may snap or twist on and off for easy cleaning or adding extermination solution 305. Vented base container 307 may be a larger diameter than fixture top 311 for increasing the distribution range of exterminating vapors 309.

FIG. 4 illustrates a perspective cutaway view of an exemplary embodiment of a solar powered dual vented container organic insect extermination lamp. Lamp 400 comprises light and heat source 401 housed in fixture 403 for vaporizing natural exterminating substance 405a, 405b from vented containers 407a, 407b respectively. Light and heat source 401 may comprise an AC powered incandescent bulb, fluorescent bulb, ultra violet bulb, LED or candle. Light and heat source 401 may be powered by any combination of solar cell 411, AC or battery. Natural exterminating substance 405a,b may comprise any Allyl Sulfide emulsion or other natural mosquito killing compound that produces exterminating vapors 409a, 409b.

Dual container embodiment 400 advantageously traps mosquitoes between two fields of natural evaporative vapors 409a, 409b. Evaporation starts at bottom container 407b and flows upward, making contact with biting insects as they approach light and heat source 401. Mosquitoes approaching toward the top of lamp 400 make contact with natural evaporative vapors 409a from top container 407a. Mosquitoes approaching horizontally from the side of lamp 400 make contact with natural evaporative vapors 409b from bottom container 407b.

Under windy or breezy conditions, where wind or breeze blows upward around lamp 400, natural evaporative vapors 409b flow upward around lamp 400 from bottom container 407b. Where wind or breeze blows downward around lamp 400, natural evaporative vapors 409a flow downward around lamp 400 from top container 407a. Wind or breeze blowing horizontally causes bottom container 407b evaporative fumes 409b to flow upward.

Vented containers 407a,b provide ducts permitting wind or breeze to flow into one side of containers 407a,b and exit out through various vents expanding the distribution range of natural evaporative vapors 409a,b. Vented containers 407a,b create small jet stream effects causing evaporating vapors 409a,b to move in concentric circles away from lamp 400.

As natural extermination substance 405a held by top container 407a is heated by light and heat source 401 to a temperature in the range of 106-109 F, natural evaporative vapors 409a flow upward. Surrounding air heated by light and heat source 401 moving upward and heated air rising from top container 407a draw natural evaporative vapors 409b from bottom container 407b upward. Mosquitoes drawn into this evaporative convection meet immediate death and fall into bottom container 407b, which becomes a collection tray as well as a vessel for natural exterminating substance 405b. Bottom container 407b may be a larger diameter than top container 407a for increasing the distribution range of exterminating vapors 409a,b.

Thus, a novel and improved method and apparatus for an organic insect extermination lamp have been described. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An insect extermination lamp comprising:
a fixture having a power supply and a light source for attracting mosquitoes and other biting insects; and
at least one container for holding a natural exterminating substance, wherein the natural exterminating substance evaporates natural exterminating vapors for killing the mosquitoes and other biting insects.

2. The insect extermination lamp of claim 1 wherein the natural exterminating substance comprises an Allyl Sulfide emulsion or other natural killing compound.

3. The insect extermination lamp of claim 1 wherein the natural exterminating substance comprises garlic oil, garlic paste, garlic emulsion, crushed fresh garlic, or other forms of natural killing compounds.

4. The insect extermination lamp of claim 1 wherein the power supply comprises any combination of Alternating Current, battery or solar cell.

5. The insect extermination lamp of claim 1 wherein the light source comprises an incandescent bulb, fluorescent bulb, ultra violet bulb, LED or candle.

6. (canceled)

7. (canceled)

8. (canceled)

9. (canceled)

10. (canceled)

11. (canceled)

12. (canceled)

13. (canceled)
